(19) United States
(12) Patent Application Publication
(10) Pub. No.: US 2003/0148540 A1
(43) Pub. Date: Aug. 7, 2003

(54) Process for reducing ligand leakage from affinity chromatography matrices

(75) Inventors: Lothar Halmer, Biberach (DE); Margit Holzer, Biberach (DE)

Correspondence Address: BOEHRINGER INGELHEIM CORPORATION, 900 RIDGEBURY ROAD, P. O. BOX 368, RIDGEFIELD, CT, 06877, US

(73) Assignee: Boehringer Ingelheim Pharma KG, Ingelheim am Rhein (US)

(21) Appl. No.: 10/295,478

(22) Filed: Nov. 15, 2002

(30) Foreign Application Priority Data
Nov. 15, 2001 (DE) 101 55 984.4

(51) Int. Cl. G01N 33/53; G01N 33/537; G01N 33/543; G01N 33/558

(52) U.S. Cl. 436/514; 210/656

(57) ABSTRACT

The present invention relates to a process for (pre)treating affinity chromatography matrices, preferably protein A matrices, with at least one surfactant for reducing ligand leakage. By treating the affinity chromatography matrix according to the invention it is possible to achieve an affinity chromatography matrix of constant quality in terms of ligand leakage, which is an important prerequisite for its suitability or use in biopharmaceutical processes. The present invention further relates to methods for determining the ligand leakage.

### BACKGROUND

The invention relates to a process for treating affinity chromatography matrices which is suitable for reducing ligand leakage. The invention further relates to low-leakage affinity chromatography matrices and methods for determining ligand leakage.

Affinity chromatography matrices, hereinafter also referred to as affinity matrices, are used in the industrial purification of various substances. Using immobilised ligands it is possible to specifically concentrate and purify substances which have a certain affinity for the particular ligands used. For the industrial purification of antibodies, particularly the purification of monoclonal antibodies, it has proved satisfactory to use immobilised protein A as the initial cleaning step. Antibodies from the mobile phase bind specifically to the protein A ligand which is covalently bound to a carrier (e.g. Sepharose). Protein A from Staphylococcus aureus (wild-type protein A) and genetically modified recombinant protein A (rec. protein A) interact with the constant region (Fc fragment) of the antibodies by non-covalent interactions. This specific interaction can be used to efficiently separate process-induced contaminants such as host cell proteins and/or media components from the antibody. By altering the pH it is possible to stop the interaction between the antibody and protein A ligands deliberately and to free or elute the antibodies from the stationary phase. During elution it has been found that not only are the desired antibodies released but also to some extent protein A, i.e. the ligand itself, is released, depending on the stability of the protein A matrix used. The release of the protein A covalently coupled to the column matrix is referred to as protein A leakage or generally as “ligand leakage”, an effect which is generally observed when using affinity chromatography matrices. The extent of the ligand leakage depends on various factors. On the one hand, the ligand leakage is influenced by the coupling efficiency with which the ligand is coupled to a carrier. A low coupling efficiency has been found to promote ligand leakage. On the other hand, ligand leakage also appears to be affected by the special process conditions under which the chromatography is carried out.

The leakage rate of the ligand used, i.e. the quantity of ligand which is washed out of the column per unit of matrix or per unit of substance to be purified, is an important quality criterion of the affinity chromatography matrices used. An excessively high ligand leakage regularly leads to a critical, quality-impairing contamination of the pharmaceutical active substance being purified. Expensive downstream purification steps are needed to separate the active substance from the ligands again. There is also the danger that insufficiently purified pharmaceutical products will trigger undesirable side effects in the patient, caused by a too high concentration of ligand.

To reduce the protein A leakage in industrial processes, the column matrix may be pre-treated under stringent buffer conditions before the protein A matrix is used for the first time and after it has been in use for some time. It is recommended that the matrix be pre-treated with a chaotropic substance such as, for example, 6 M urea or 6 M guanidine hydrochloride (1 bed volume).

In addition to this pre-treatment the column matrix is purified before and after each column run. The corresponding processes serve primarily to maintain the hygiene of the process (CIP). For CIP/gel purification of protein A Sepharose it is recommended that the column matrix be rinsed with two column volumes (cv) of a 0.1% non-ionic detergent at 37° C. The contact time is given as one minute. To reduce possible microbial contamination, it is also advised that the matrix be treated for 6 hours with 2% hibitane-(2)-gluconate and 20% EtOH and then carefully rinsed with a binding buffer (pH 7-8). For the CIP of “STREAMLINE™ rprotein A” made by Messrs Amersham Pharmacia Biotech (Uppsala, Sweden) a treatment of the protein A matrix with 5% sodium-N-lauroylsarcosinate, 20 mM EDTA and 0.1 M NaCl in phosphate buffer is specified (“STREAMLINE™ rprotein A” Manual, Amersham Pharmacia Biotech, Code 18-1115-67). As our own experiments have proved, however, (Table 1, FIG. 1), these processes are not effective enough to reduce the protein A leakage to a reliably and reproducibly low level.

For the preparation of biopharmaceutical medicaments, it is of supreme importance to use stable protein A matrices with a reproducibly low protein A leakage. At present, however, matrices of this kind with a constantly low leakage are not available with a sufficient reliable quality. This is illustrated by way of example in Table 1 (FIG. 1) for different batches of a protein A Sepharose.

The aim of the present invention was to develop and establish a suitable process for pretreating and/or treating affinity chromatography matrices, which ensures that the ligand leakage is reduced to a reproducibly low level and thus as a result can guarantee affinity matrices of constant quality. It was especially important to provide a suitable process for pretreating protein A matrices which are used particularly for purifying antibodies.

### SUMMARY OF THE INVENTION

The invention relates to processes for treating an affinity chromatography matrix comprising treating the affinity chromatography matrix with at least one surfactant for at least 4 hours. The affinity chromatography matrix may be pre-treated and/or post-treated with the following solutions: a chaotropic substance, an acidic elution buffer having a pH of about 2.0 to about 4.0, and a neutral equilibration buffer having a pH of about 6.5 to about 8.5. The column may be treated with the solutions either serially or in combination. Treatment with the surfactant may be in combination with the pre- or post-treatment steps. In an embodiment, the affinity chromatography matrix is treated with 5 to 15 bed volumes of at least one surfactant. In another embodiment, the affinity chromatography matrix is treated a process temperature ranging from about 25° C. to 55° C. In an embodiment, the surfactant is a non-ionic detergent or a zwitterionic detergent, including, but not limited to, polyoxyethylene(23)laurylether, polyoxyl-20-cetostearylether, polyoxyethylene(20) sorbitan-monolaurate (Polysorbate 20), polyoxyethylene(20)sorbitan monooleate (Polysorbate 80), t-octylphenoxy-polyethoxyethanol, polyglycolether, isooctylphenoxypolyethoxyphenol, polyoxyethylene-polyoxypropylene block copolymer, polyethylene glycol, 3-(3-cholamidopropyl)-dimethylammonio-1-propanesulphonate (CHAPS), or 3-(3-cholamidopropyl)-dimethyl-ammonio-2-hydroxy-1-propanesulphonate (CHAPSO).

The invention also relates to low leakage the affinity chromatography matrices prepared according to the methods of the invention. The invention also relates to methods for determining ligand leakage comprising treating an affinity chromatography matrix according to the processes of the invention. The invention also relates to the use of low leakage the affinity chromatography matrices prepared according to the methods of the invention for purifying biopharmaceutical products, including but not limited to, antibodies, chimeric antibodies, and fragments and derivatives thereof.

### DESCRIPTION OF THE FIGURES

FIG. 1 describes the different ligand leakage from protein A sepharoses which have not been pre-treated by one of the processes according to the invention.

FIG. 2 describes a process according to the invention for determining the protein A leakage from a protein A matrix. FIG. 2 is an illustration of the incubation test according to the invention.

FIG. 3 describes a process according to the invention for determining the protein A leakage from a protein A matrix. FIG. 3 is a description of the small scale process according to the invention.

FIG. 4 shows the effect of pretreating a protein A matrix with a high and low protein A leakage on the reduction in the protein A leakage.

FIG. 5 shows the influence of the treatment of a protein A matrix by the process according to the invention on the reduction in protein A leakage, when the matrix is repeatedly charged with a biological probe in the small scale process.

FIG. 6 shows the effect of the concentration of Tween 20 on the reduction in protein A leakage.

FIG. 7 shows the effect of the concentration of Pluronic® F68 on the reduction in protein A leakage.

FIG. 8 shows the effect of the concentration of Trition-X-100 on the reduction in protein A leakage.

FIG. 9 shows the effect of the concentration of CHAPS on the reduction in protein A leakage.

FIG. 10 shows the effect of the concentration of polyethylene glycol on the reduction in protein A leakage.

FIG. 11 describes the influence of the treatment time on the reduction in protein A leakage.

FIG. 12 describes the influence of the treatment temperature on the reduction in protein A leakage. (A, B) and (C, D) show two tests carried out independently.

FIG. 13 describes the detergent-dependent reduction in protein A leakage for various protein A matrices.

FIG. 14 describes the reduction in protein A leakage as a function of the time, temperature and rinsing volume; the rinsing volume being directly dependent on the length of treatment. (A) * The protein A leakage rate without pre-treatment of the matrix is set at 100% (=initial value). (B) -♦- % Prot. A-leakage (25° C.); -●- % Prot. A-leakage (37° C.)

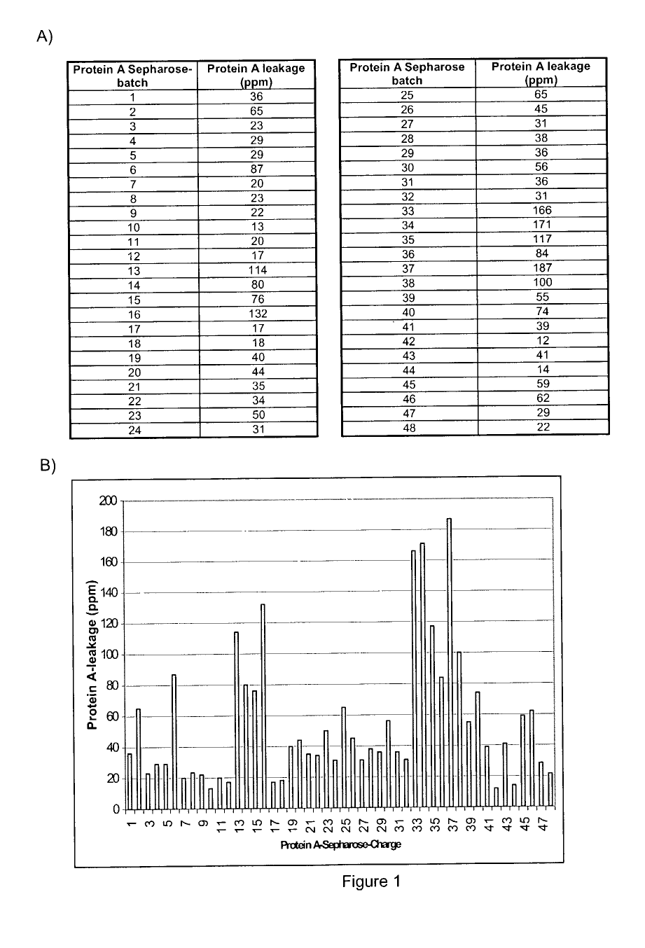

### DESCRIPTION OF THE INVENTION

The present invention relates to a process for pretreating and/or treating affinity chromatography matrices, which ensures that the ligand leakage is reliably and reproducibly reduced and can thus guarantee a constant quality of affinity chromatography matrices, without negatively affecting the activity of the affinity chromatography matrix and/or its chromatographic properties. The term “treatment” hereinafter also means pre-treatment of the affinity chromatography matrix before it is used for chromatographic purposes.

“A” or “an” is understood to mean one or more, e.g., “a surfactant” is meant to mean one or more surfactants.

Surprisingly, a process has been found which includes as an essential step the treatment of the affinity chromatography matrix with a surfactant. Surfactants for the purposes of the invention are both non-ionic and ionic detergents, including zwitterionic detergents. Such treatment of an affinity chromatography matrix according to the invention is also referred to hereinafter as “detergent treatment”.

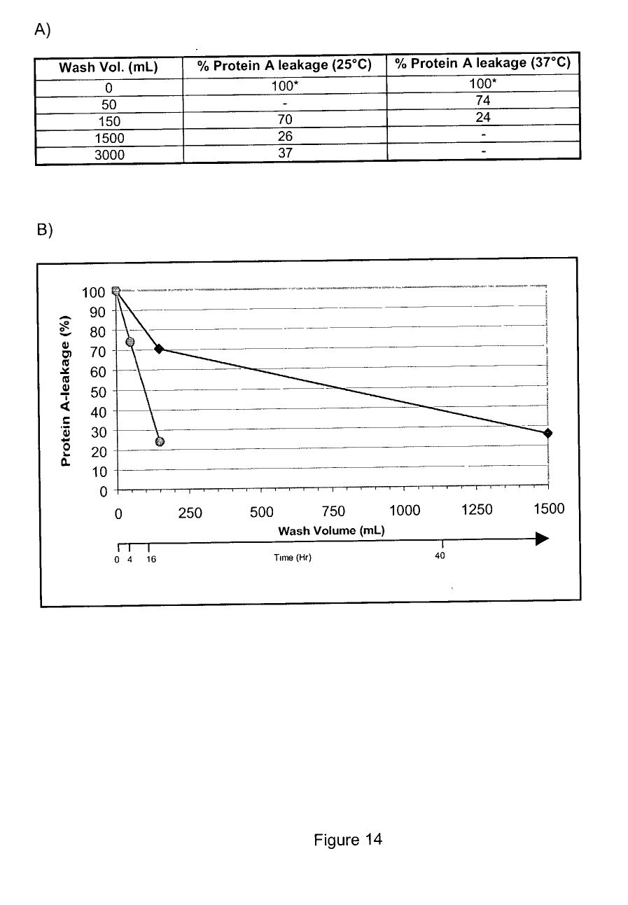

The effectiveness of the process according to the invention is crucially determined by the length of treatment (contact time), the volume, the temperature and the surfactant used. Surprisingly, it has been found that there is no linear correlation between the length of treatment and the reduction in ligand leakage at the start of the treatment time. It turns out that a contact time (duration of treatment) of less than about 16 hours had little or no effect on the reduction in ligand leakage at room temperature (RT) (FIGS. 11 and 14). Room temperature denotes temperatures between 15° C. and 25° C. Only after a treatment time of about 16 hours at RT was there a significant reduction in ligand leakage. The amount of protein A shown in FIG. 11 is inversely proportional to the ligand leakage displayed by a protein A matrix after suitable pre-treatment.

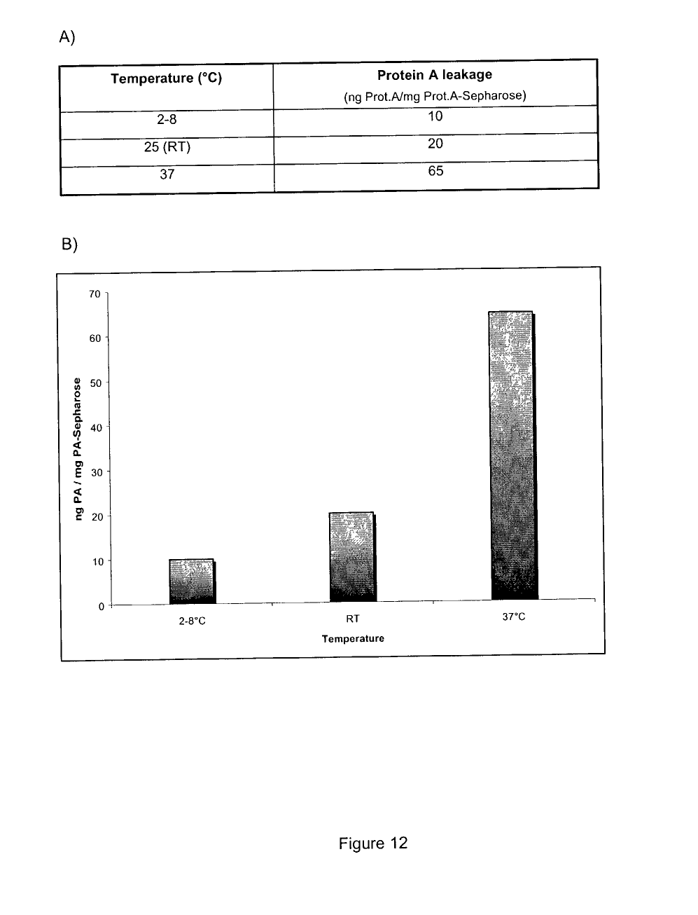

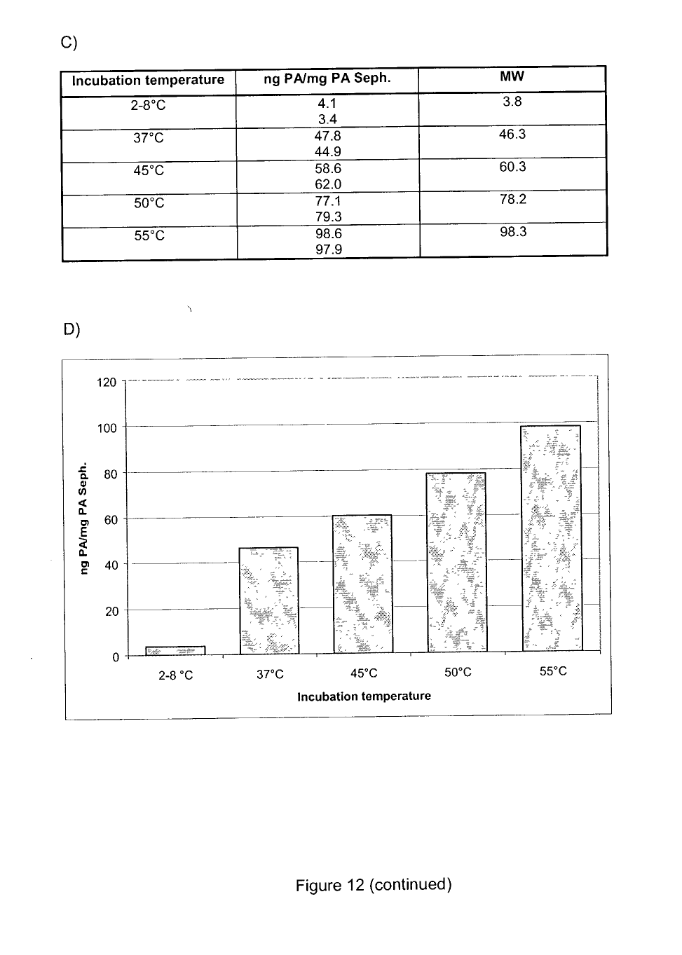

By increasing the duration of treatment the ligand leakage can be further reduced. However, the length of treatment needed decreases as the temperature increases (process temperature). At a temperature above 25° C., particularly at 30 to 40° C. and especially at 36 to 38° C., the treatment time of the process according to the invention which is needed to reduce the ligand leakage to a reproducibly low level without affecting the activity of the affinity chromatography matrix or the chromatographic properties is reduced to 4 to 16 hours (FIG. 14). FIG. 12 shows that a further increase in temperature, e.g. to 55° C., has a further positive effect on ligand leakage, i.e. it leads to a reduction in the ligand leakage according to the invention.

The invention therefore relates to a process for reducing ligand leakage, comprising treating an affinity chromatography matrix with at least one surfactant for at least 16 hours, preferably for 16 to 48 hours, at 15 to 25° C. (RT). The process may be carried out for the same treatment time (16 to 48 hours) but at temperatures below 15° C. (RT), while treatment at RT is preferred. At temperatures above 25° C., particularly between 30 to 40° C., particularly at 36 to 38° C., the length of treatment according to the invention is at least 4 hours. A corresponding process in which the contact time is between 4 and 16 hours is particularly preferred. A further temperature increase to temperatures above 40° C. may lead to a further shortening of the contact time. Temperatures up to about 55° C., particularly temperatures between 40 to 55° C., particularly between 50 to 55° C., are especially preferred. The optimum contact time depending on the incubation temperature may very easily be determined without much effort using one of the methods described in this application for determining ligand leakage (incubation test, small scale process). Generally, a process in which the process temperature is between 25 and 55° C. and the contact time is between 4 and 16 hours is preferred. At room temperature or below, the contact time of the process according to the invention is at least 16 hours, preferably between 16-48 hours.

Another embodiment of the invention comprises treating the affinity chromatography matrix for at least 16 hours at RT with at least 5-30 bed volumes, preferably with not less than 10 bed volumes, of at least one surfactant. In addition, one process according to the invention comprises treating the affinity chromatography matrix for at least 4 hours at a temperature of 36-38° C. with at least 5-15 bed volumes of at least one surfactant. In this last process the temperature may also be increased to above 38° C., for example to temperatures up to about 55° C. As illustrated in FIG. 12, a corresponding temperature increase results in a further reduction in the ligand leakage.

However, the invention also relates to processes wherein the contact time is less than 4 hours for temperatures above 25° C. and less than 16 hours for temperatures up to 25° C., insofar as the process as a whole is capable of reducing the ligand leakage to a reproducibly low level without affecting the activity of the affinity chromatography matrix or the chromatographic properties. The positive influence of increasing reaction temperatures on the reduction in ligand leakage is apparent from FIG. 12, for example.

A reproducibly low level for the purposes of the invention means for example that the ligand leakage of an affinity chromatography matrix, determined by one of the methods of determining ligand leakage described hereinafter (incubation test, small scale process), has a value of less than 80 ng of ligand/mg affinity matrix. In a preferred embodiment of the invention the ligand leakage determined using one of these methods has a value of less than 40 ng ligand/mg affinity matrix, in a particularly preferred embodiment it is less than 20 ng ligand/mg affinity matrix, and in another particularly preferred embodiment of the invention it is less than 10 ng ligand/mg affinity matrix.

The processes according to the invention described herein are particularly suitable for reducing the ligand leakage from protein A matrices. Consequently, the processes described here are deemed to be processes according to the invention if they are used to treat protein A matrices. Protein A matrices for the purposes of the invention are affinity chromatography matrices which contain immobilised protein A as ligand. This includes affinity matrices which contain wild-type protein A, for example from Staphylococcus aureus, as ligand. Protein A is described, inter alia, by Lofdahl, S. et al., (Lofdahl, S. et al., 1983, PNAS USA 80(3):697-701) and Lindmark et al., (Lindmark et al., 1983, J. Immunol. Methods 62(1):1-13). The invention further relates to matrices with recombinantly produced protein A as ligand. Recombinant protein A is described, for example, by Duggleby C. J. and Jones, S. A., (Duggleby C. J. and Jones, S. A., 1983, Nucl. Acid Res. 11(10):3065-3076) or Li, R. et al. (Li, R. et al., 1998, Nat. Biotechnol. 16(2):190-195) and known to the skilled artisan.

Protein A may be coupled to various carrier materials such as, for example, agaroses, polysaccharides, dextrans, silica gels and glass beads. A by no means exhaustive list of suitable carrier materials is found in Harlow, E. and Lane, D. (Harlow, E. and Lane, D., Laboratory Manual of Antibodies. Cold Spring Harbor Laboratory Press, New York, 1999). One frequently used carrier material is formed from agarose-based materials such as the “sepharoses” produced by Amersham Pharmacia Biotech, Uppsala, Sweden, that is known to the skilled artisan. Specific examples of protein A sepharoses can be found in the Manual produced by Amersham Pharmacia Biotech on the subject of “Affinity Chromatography” dating from 2001. In addition, the skilled artisan is familiar with other protein A chromatography matrices, such as e.g. MabSelect™ (Messrs Amersham Pharmacia Biotech, Uppsala, Sweden), STREAMLINE™ rprotein A, (Messrs Amersham Pharmacia Biotech, Uppsala, Sweden) and Poros™ A (Millipore, Durham, England). The process according to the invention includes treatment of the corresponding matrices, while the list of matrices is provided by way of example and is not intended to be exhaustive.

The coupling of the ligand is generally affected via free amino, carboxyl or sulphur groups by cyanogen bromide, activation, NHS activation or thiol coupling to the carrier matrix. See for example the Manual “Affinity Chromatography”, Amersham Pharmacia Biotech, Uppsala, Sweden, 2001.

In addition to giving the ligand leakage in ng ligand/mg affinity matrix, it is useful to have data in ng protein A/mg antibody (=ppm), particularly for the ligand leakage of protein A-sepharose, as it specifies the concentration of the ligand (process contaminant) in relation to the concentration of the antibody. The numerical values described above for a reproducibly low level of ligand leakage in ng ligand/mg affinity matrix largely correspond to one another.

Accordingly, a reproducibly low level of protein A leakage corresponds for example to a leakage determined by one of the methods of determining ligand leakage described hereinafter (incubation test, small scale process), of a value of less than 80 ppm of protein A. In a preferred embodiment of the invention the protein A leakage determined by one of these methods has a value of less than 40 ppm protein A, in a particularly preferred embodiment it has a value of less than 20 ppm protein A, and in another particularly preferred embodiment of the invention it has a value of less than 10 ppm protein A.

The effectiveness of the process according to the invention by which the ligand leakage, particularly the protein A leakage, can be reduced can be increased by subjecting the matrix to additional treatment steps. One process which has proved effective comprises pre- and/or after-treatment of the affinity matrix with a chaotropic substance in addition to the detergent treatment (with at least one surfactant).

In a preferred embodiment of this process, the treatment step with a chaotropic substance is followed by an elution buffer which is stringent for the affinity matrix. By the phrase “an elution buffer which is stringent for the affinity matrix” is meant, for the purposes of the invention, elution buffers which allow specific elution of a substance which is to be purified from its ligand. For example, if the substance which is to be purified is an antibody and the ligand is protein A, an acidic elution buffer (pH 2.0-4.0) satisfies the requirements of a stringent elution buffer for the purposes of the invention (Affinity Chromatography—Principles and Methods, page 63, Amersham Pharmacia Biotech, Uppsala, Sweden).

In a particularly preferred embodiment the washing step with a buffer which is stringent for the affinity matrix is followed by another washing step with a neutral buffer, the pH of which is between 6.5 and 8.5 for example.

Accordingly, the invention relates to processes which comprise, in addition to the above-mentioned “detergent treatment”, one of the following steps:

(A) treating the matrix with a chaotropic substance; or

(B) treating the matrix with a chaotropic substance followed by a washing step with an elution buffer which is stringent for the affinity matrix; or

(C) treating the matrix with a chaotropic substance, followed by a washing step with an elution buffer which is stringent for the affinity chromatography and a neutral washing buffer, preferably pH 6.5-8.5,

particularly when one of these steps precedes and/or follows the detergent treatment. In a particularly preferred process the chaotropic substance is urea or guanidine hydrochloride, preferably in a concentration of 4 to 6 M.

A corresponding process is especially suitable for reducing the ligand leakage from protein A matrices and consequently the invention particularly relates to a process wherein an acidic elution buffer is used, preferably one having a pH of 2.0 to 4.0.

Another preferred embodiment of the invention relates to a process which comprises or consists of the following steps:

(A) pretreating the affinity chromatography matrix with a chaotropic substance, followed by an acidic buffer, preferably pH 2.0 to 4.0, and a neutral buffer, preferably pH 6.5-8.5;

(B) treating the affinity chromatography matrix with at least one surfactant according to one of the processes described above which is suitable for reducing the ligand leakage;

(C) subsequently treating the affinity chromatography matrix with a chaotropic substance, followed by an acidic buffer (pH 2.0 to 4.0) and a neutral washing buffer (pH 6.5-8.5).

In another embodiment of this invention, the acid elution buffer may be replaced by any desired elution buffer which is stringent for an affinity matrix. Preferably, the process according to the invention described above may in turn be used to reduce the ligand leakage from protein A matrices.

Surfactants for the purposes of the invention are both non-ionic and ionic detergents, particularly zwitterionic detergents. The non-ionic detergents are preferably selected from among the polyethylene glycol (PEG)-alkylethers, PEG-sorbitan fatty acid esters, alkylphenyl-PEG-ethers or polyethyleneoxide polypropyleneoxide (PEO-PPO) block copolymers. In a particularly preferred embodiment of the invention, PEG-alkylethers such as polyoxyethylene(23)laurylether (Brij 35, C₁₂H₂₅(OCH₂CH₂)ₙOH, n˜23, CAS: 9002-92-0) and polyoxyl-20-cetostearylether, or PEG-sorbitan fatty acid esters (Polysorbate derivatives) such as polyoxyethylene(20)sorbitan-monolaurate (Polysorbate 20, CAS: 9005-64-5) or polyoxyethylene (20)sorbitan-monooleate (Polysorbate 80, CAS: 9005-65-6), or alkylphenyl-PEG-ethers (octoxynol derivatives), such as t-octylphenoxypolyethoxyethanol (Triton-X-100, CAS: 9002-93-1), or a nonylphenolpolyoxyethylene ether such as polyglycolether (non-ionic surfactants) type NP-40 (Tergitol NP40, CAS: 127087-87-0) or branched polyoxyethylene-nonylcyclohexyl ether (Triton N-101, C₉H₁₉C₆H₁₀(OCH₂CH₂)ₙOH, (isooctylphenoxypolyethoxyphenol) CAS: 123359-41-1), or PEO-PPO-block copolymers (Poloxamer derivatives), such as polyoxyethylene-polyoxypropylene block copolymer (Pluronic® F-68, Lutrol® F68, Poloxamer 188, CAS: 9003-11-6 or Poloxamer 407, Pluronic F-127, Lutrol® F 127, CAS: 9003-11-6) are used. It is also suitable to use polyethylene glycol (PEG) for treating the affinity matrices, and the invention therefore also relates to the use thereof.

By polyglycolether (non-ionic surfactants) type NP-40 (Tergitol NP40, CAS: 127087-87-0) is meant a compound having the following structural formula:

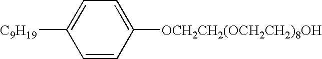

By polyoxyethylene-polyoxypropylene block copolymers (Pluronic® F-68, Lutrol(® F 68, Poloxamer 188, CAS: 9003-11-6) are meant compounds with the following structural formula:

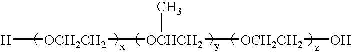

By polyoxyethylene-polyoxypropylene block copolymers (Pluronic F 127, Lutrol® F 127, Poloxamer 407, CAS: 9003-11-6) are meant compounds with the following structural formula:

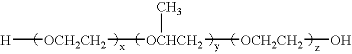

Of the zwitterionic detergents, 3-(3-cholamidopropyl)-dimethylammonio-1-propanesulphonate (CHAPS, CAS: 75621-03-3) or 3-(3-cholamidopropyl)-dimethyl-ammonio-2-hydroxy-1-propanesulphonate (CHAPSO, CAS: 82473-24-3) are particularly suitable for the treatment of the matrices according to the invention.

The non-ionic detergents are preferably used in a concentration of 0.001 to 5% (v/v). It is particularly preferable to use Polysorbate (20 and 80) in a concentration of greater than 0.005% (v/v), Pluronic (F68) in a concentration of greater than 0.001% (v/v) and Triton-X-100 in a concentration of greater than 0.001% (v/v). In another embodiment of the invention Polysorbate, preferably Polysorbate 20, is used in a concentration of 0.005 to 0,5% (v/v), and Pluronic, preferably Pluronic® F-68, and Triton™ X-100 are used in a concentration of greater than 0.001-0,1% (v/v). Polyethylene glycol is also suitable in a concentration of greater than 0.01 (v/v), but is preferably used in a concentration of 0.01-1%.

Zwitterionic detergents are preferably used in a concentration of 0.01 to 1% (v/v), while the detergents CHAPS and/or CHAPSO are most preferably used in a concentration greater than 0.01% (v/v). In another embodiment the concentration of CHAPS and/or CHAPSO is 0.01 to 1% (v/v).

The invention also relates to the treatment of the affinity chromatography matrices, preferably the treatment of protein A matrices with a combination of said detergents. In addition to processes for reducing the ligand leakage the present invention also relates to “low leakage” affinity chromatography matrices which have been treated by one of the methods of reducing ligand leakage according to the invention described above. In a preferred embodiment the invention relates to low leakage protein A matrices insofar as they have been treated by a corresponding method of reducing the protein A leakage. Low leakage protein A matrices means both matrices which contain wild-type protein A, such as for example protein A from Staphylococcus aureus, and those containing recombinantly produced protein A. Examples which may be mentioned are: protein A sepharoses and protein A sepharose beads (e.g. STREAMLINE™ rproteinA of Messrs Amersham Pharmacia Biotech, Uppsala, Sweden), although the list is purely by way of example and not intended to be exhaustive.

In addition to the above-mentioned methods of reducing the ligand leakage from affinity matrices and low leakage affinity chromatography matrices which have been treated accordingly, the present invention includes methods of determining the ligand leakage. One such method is referred to hereinafter as the incubation test, another as the small scale process.

The incubation test according to the invention comprises steps (A) to (C) described hereinafter, and in a particularly preferred embodiment the incubation test consists of the following steps:

(A) Pretreating the affinity chromatography matrix by one of the processes described above according to the invention, which is suitable for reducing the ligand leakage;

(B) Incubating the pre-treated affinity chromatography matrix with an additional solution, which is also referred to as the probe; and

(C) Quantifying the ligand in the additional solution (probe) using a suitable quantitative test, which may be, for example, a ligand-specific ELISA.

In a particular embodiment of the inventive method shown here for determining the ligand leakage, the affinity chromatography matrix is pre-treated in Step A as follows:

In a first step (Step (A1)) the affinity matrix is treated with a chaotropic substance, preferably with urea or guanidine hydrochloride, most preferably in a concentration of 4-6 M, followed by a washing step with an elution buffer which is stringent for the affinity matrix, followed by a washing step with a neutral buffer, preferably with a pH of 6.5-8.5.

In step (A2) the affinity matrix is treated with several bed volumes, preferably 5 to 30, of at least one surfactant, the contact time being at least 4 hours and the incubation temperature being between 25 to 37° C. However, the temperature may also be increased to above 37° C., for example, to levels of up to about 55° C.

In step (A3) the affinity chromatography matrix is again treated with a chaotropic substance, preferably with urea or guanidine hydrochloride, most preferably in a concentration of 4-6 M, followed by a washing step with an elution buffer which is stringent for the affinity matrix, followed by a washing step with a neutral buffer, preferably with a pH of 6.5-8.5.

The additional solution mentioned in step (B) is preferably a probe which corresponds to the intermediate product used as the starting material for the affinity chromatography under production conditions. If for example the affinity chromatography is the initial purification step, it may be the harvest probe from a fermentation process, for example. However, it is also conceivable according to the invention to use cell culture medium or any desired buffer. In another preferred embodiment of the invention the additional probe is the eluate which is obtained under the process conditions. In a particular embodiment, the contact time for the treatment of the probe (step B) is not less than 8 hours, with the incubation temperature being not less than 18° C. and preferably around 37° C.

The quantitative determination of the ligand may be carried out using any desired method of measurement known in the art which is suitable for quantifying the ligand. In the case of a protein-containing ligand, for example, the protein may be measured by the Biuret or Lowry method (Harris, E. L. V. and Angal, S., IRL Press, Oxford University Press Inc., New York, 1989). Another method of quantifying protein or peptide ligands is to exploit the antibody-antigen interactions. The use of corresponding test systems in which the ligand is detected by means of a specific antibody directed against this ligand is described for example in “Immunoassay”, Diamandis, P. and Christopoulos T. K. (Diamandis, P. and Christopoulos T. K., Immunoassay, Academic Press, 1996), and may be carried out by a skilled person without any inventive effort. The methods mentioned here are purely examples and should not be regarded as an exhaustive list.

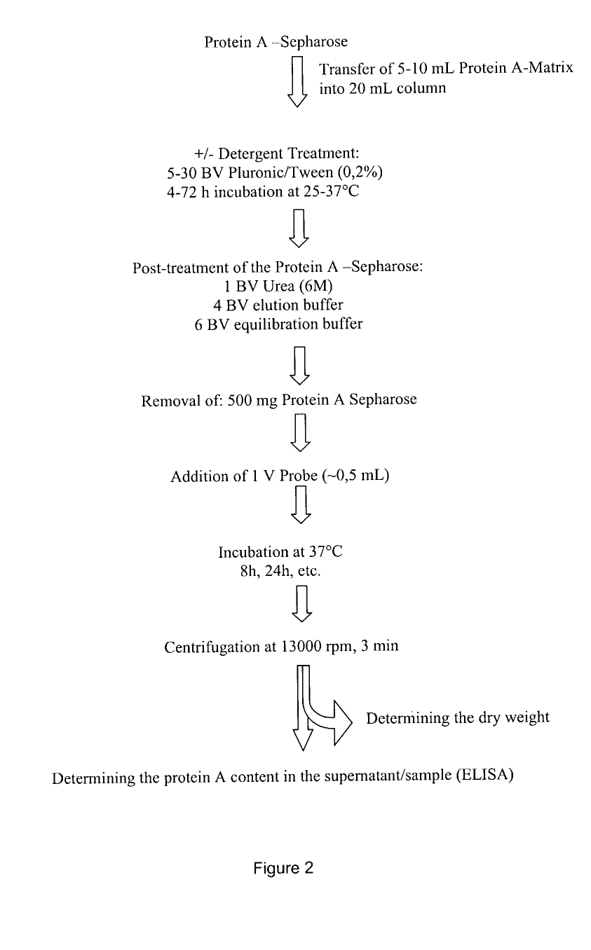

The invention relates in particular to the embodiments described above of the method of determining the ligand leakage from protein A matrices. In one corresponding method an acid buffer, most preferably a buffer with a pH of 2.0 to 4.0, is used as the elution buffer. Another embodiment of the method of determining the protein A leakage is described in the Examples (see below). The invention further relates to the method of determining protein A leakage illustrated in FIG. 2.

One preferred method of detecting protein A is the use of a so-called “sandwich protein A ELISA”, for example, which can also detect small amounts (ppm) of protein A. The principle of such a test is described for example in “ELISA”, Kemeny, D. M. (1994, Gustav Fischer Verlag), and can readily be used by anyone skilled in the art. For the protein A ELISA a high affinity anti-protein A-antibody is fixed to a reaction vessel, primarily a 96-well microtiter plate. The detection of protein A in the sample being analysed is carried out after incubating the sample with the fixed anti-protein A-antibody using a second, equally high affinity anti-protein A-antibody which is additionally labelled with an enzyme, for example a peroxidase or alkaline phosphatase. Corresponding unlabelled anti-protein A-antibodies and/or those which have been labelled with an enzyme are known in the art and may be obtained e.g. from the companies American Research Products, Inc. (Belmont, USA), Biogenesis Ltd. (Poole, England) or O.E.M. Concepts, Inc. (New Jersey, USA). A corresponding incubation test also serves as a reference method for determining the thresholds according to the invention for a reproducibly low level of ligand leakage, particularly for an admissible protein A leakage.

The invention also relates to incubation tests which are based on the same principle and which differ solely by changes in the buffer composition and/or the incubation conditions. Other tests based on the same principle are those wherein an affinity matrix is incubated with different solutions and the quantity of ligand in at least one solution is determined, as a measurement of the ligand leakage.

The invention further relates to another method of determining ligand leakage. This is a process which can be used to determine ligand leakage under process conditions and is hereinafter also referred to as the small scale process. The method according to the invention comprises or consists of the steps described below:

(A) Pretreating the affinity chromatography matrix by one of the methods according to the invention described above which is capable of reducing the ligand leakage;

(B) Charging the affinity chromatography matrix with a substance which is to be purified;

(C) Washing the affinity chromatography matrix with a specific washing buffer;

(D) Incubating the affinity chromatography matrix with a stringent elution buffer;

(E) Quantifying the ligand in the elution buffer using a suitable quantitative test, which may be, for example, a ligand-specific ELISA.

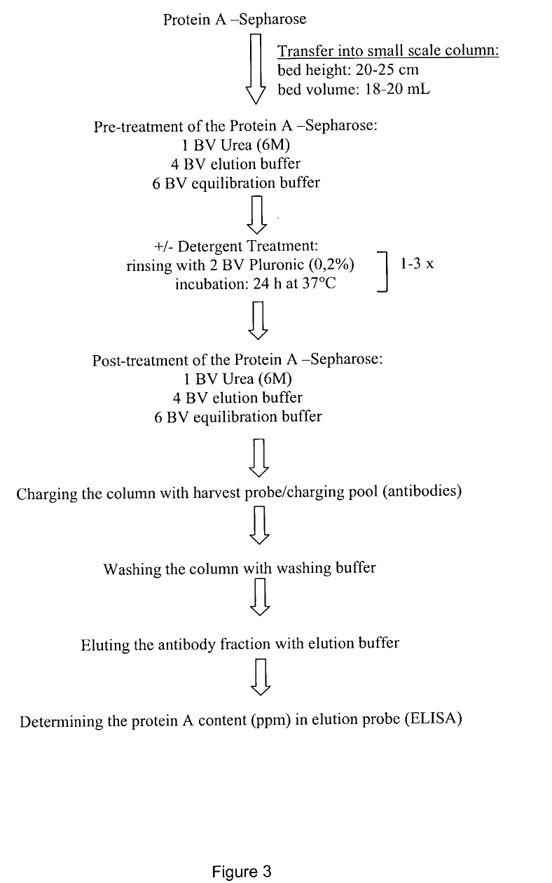

According to the invention the method may be used both for batch processes and also for column-chromatographic methods. A preferred embodiment of this method is used to determine the ligand leakage from protein A matrices. A corresponding method according to the invention is described in the Examples. One particular embodiment is the method of determining the protein A leakage which substantially corresponds to the process illustrated in FIG. 3 of the drawings.

The invention further relates to a process wherein one of the processes according to the invention for reducing ligand leakage from affinity chromatography matrices is used in the purification of biopharmaceutical products. Accordingly, the invention also relates to a process wherein low leakage affinity chromatography matrices are used to purify biopharmaceutical products. Low leakage affinity matrices for the purposes of the invention are those matrices which have been treated or pre-treated by one of the inventive methods described here. Biopharmaceutical products for the purposes of the invention are proteins, peptides, nucleic acids and the derivatives thereof. Consequently, the invention also relates to the use of a process for reducing ligand leakage from affinity chromatography matrices and the use of low leakage affinity chromatography matrices in the purification of biopharmaceutical products.

One particular embodiment is a process in which one of the processes described here for reducing protein A leakage is used in the purification of antibodies or chimeric antibody molecules, including the fragments or derivatives thereof, and its use as such. The invention therefore also relates to a process wherein low leakage protein A matrices are used for the purification of said antibodies, chimeric antibody molecules, including the fragments or derivatives thereof, i.e. a process using protein A matrices, which have been treated or pre-treated by one of the inventive methods for reducing protein A leakage described here. The invention also relates to the use of the low leakage protein A matrices for purifying said antibodies, chimeric antibody molecules, including the fragments or derivatives thereof.

Included herein are exemplified embodiments, which are intended as illustrations of single aspects of the invention. Indeed, various modifications of the invention in addition to those herein will become apparent to those skilled in the art from the foregoing description and drawings. Such modifications are intended to fall within the scope of the present invention.

All publications and patent applications cited herein are incorporated by reference in their entireties.

### EXAMPLES

Test description: The ligand leakage was analysed by way of example for protein A matrices in an incubation test or small scale process. To do this, the chromatography matrix, in this case protein A sepharose, was treated according to one of the methods shown in FIGS. 2 and 3 and then incubated or charged with a solution (probe) of interest. The probe used was cell culture medium or a harvest probe from the fermentation process:

In step 1 (Pre-treatment) the protein A sepharose was serially pre-treated with one bed volume (BV) of urea buffer (6M), four BV of an acid elution buffer (0.1M NaCl, pH 4.0) and six BV of a physiological equilibration buffer (30 mM Tris-HCl, 0.15M NaCl, pH 7 to 8).

In step 2 (Treatment) the protein A matrix was treated over a period of between 4-48 hours with a detergent, primarily 0.2% Pluronic or 0.2% Tween 20, at 25 C.-37° C. This corresponds to roughly five to thirty BV of buffer (step 2).

Then in step 3 (Post-treatment) the matrix was rinsed with one bed volume (BV) of the urea buffer (6M), four BV of an acid elution buffer (0.1M NaCl, pH 4.0) and six BV of a neutral buffer (30 mM Tris-HCl, 0.15M NaCl, pH 7 to 8).

Step 1 (pre-treatment) or step 3 (post-treatment) are optional. Alternatively, step 1 and step 2 or step 2 and step 3 may be combined.

To determine the protein A leakage in the incubation test a sample of protein A sepharose was taken from a suitably pre-treated matrix and incubated with a volume of a specific probe over a certain length of time. Cell culture medium was used as the probe in most cases. However, it is also possible to use acid elution buffer or any desired buffer. The protein A matrix was then separated by centrifugation (5 min., 13000 rpm, Expender Rotor F45-24-11). The protein A leakage was then determined from the amount of protein A in the sample (see below).

Alternatively, the protein A leakage was determined by the small-scale process directly based on the industrial purification process used. For this, the matrix according to treatment steps 1-3 (see above) was charged with a charging buffer which contains the selected substance to be purified. Then the affinity matrix was washed under process conditions with a washing buffer (30 mM Tris-HCl, 0.15M NaCl, pH 7-8). This was followed by an elution step with an acid elution buffer (0.1 M NaCl, pH 4.0). The eluate was collected and the quantity of protein A was determined as a measurement of the protein A leakage.

In both cases the protein A was determined by sandwich protein A ELISA, which can detect even tiny amounts (ppm) of protein A. To do this, a high-affinity anti-protein A antibody was fixed to a reaction vessel, primarily a 96-well microtitre plate. The protein A was detected after incubation of the sample with the fixed anti-protein A antibody by means of a second, equally high affinity anti-protein A antibody which was additionally labelled with an enzyme, for example a peroxidase or alkaline phosphatase. Corresponding unlabelled and enzyme-labelled anti-protein A antibodies are known to the skilled man and may be obtained for example from the companies American Research Products, Inc. (Belmont, USA), Biogenesis Ltd. (Poole, England) or O.E.M. Concepts, Inc. (New Jersey, USA). Alternatively, a commercial test kit (ELISA) for detecting the protein A may be obtained e.g. from Messrs ReliGen Corp. (Needham, USA). The test was carried out according to the manufacturer's instructions.

Results: Pre-Treatment of Protein A Sepharose for Reducing the Protein A Leakage

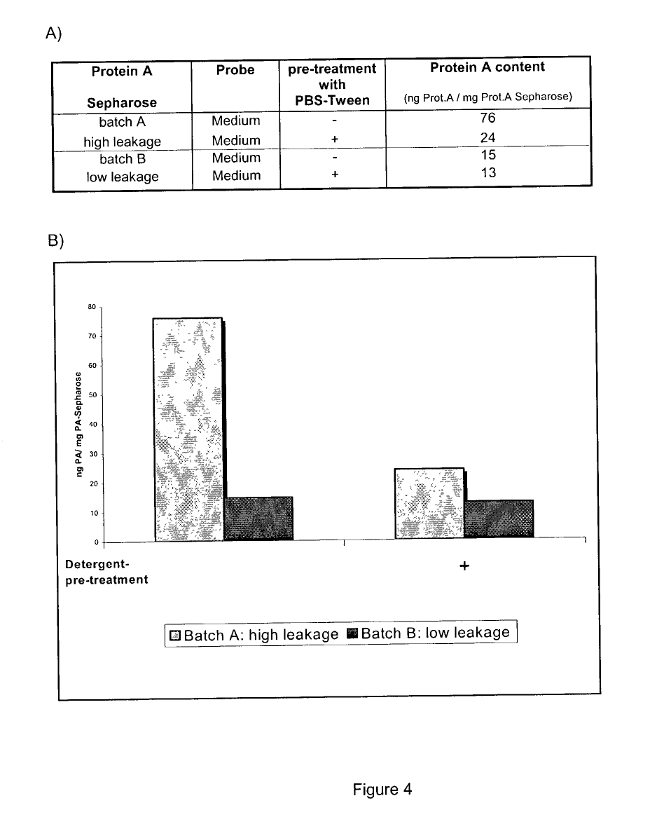

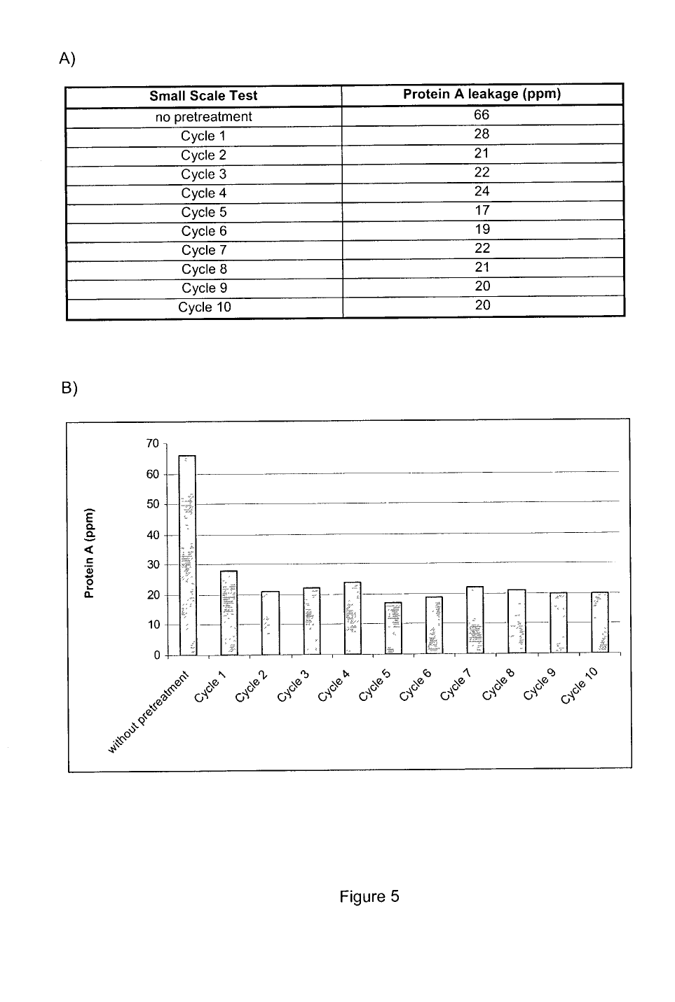

The protein A leakage characteristics of a protein A matrix which exhibits a high protein A leakage were significantly reduced by combined pre-treatment of the affinity matrix for 16 hours at 37° C. with a urea buffer, elution buffer, equilibration buffer and non-ionic detergent (FIG. 4). The detergent concentration used was 0.2% Tween 20. Following the treatment step was followed by the post-treatment step described above. The probe used was cell culture medium. The protein A leakage characteristics of a protein A sepharose, which already has low leakage before the treatment, remained stable and unaffected by the pre-treatment (FIG. 4). The pre-treatment of the protein A matrix described did not have a negative effect either on the activity of the affinity matrix or on its chromatographic properties (performance). The protein A sepharoses treated as described in FIG. 3 using an antibody solution as the probe exhibited stable ligand leakage over numerous charging and eluting cycles (FIG. 5) and remain stable and unaffected in their capacity and elution characteristics.

Induction of the Protein A Leakage as a Function of the Detergent Concentration

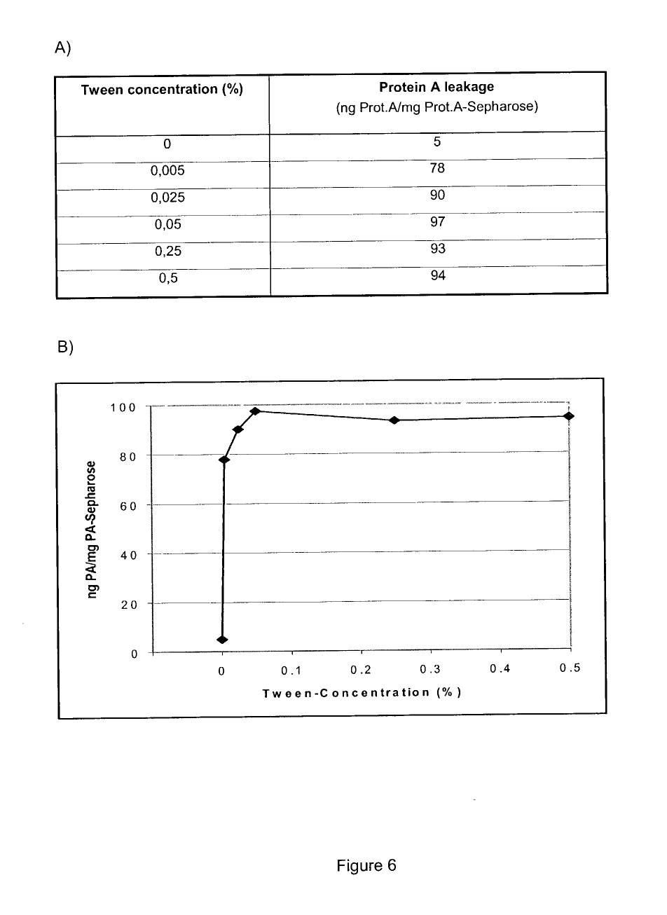

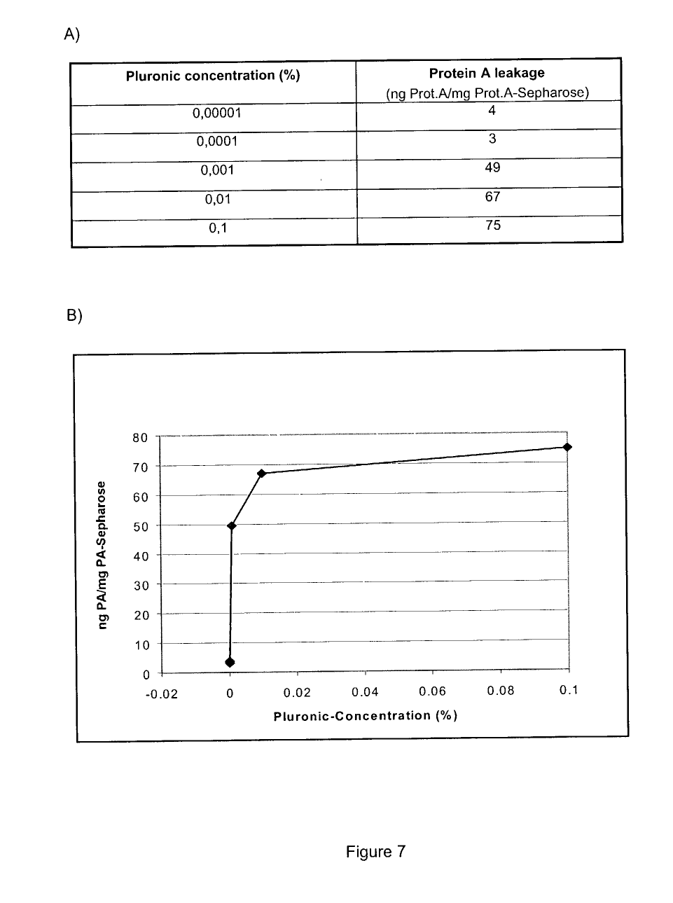

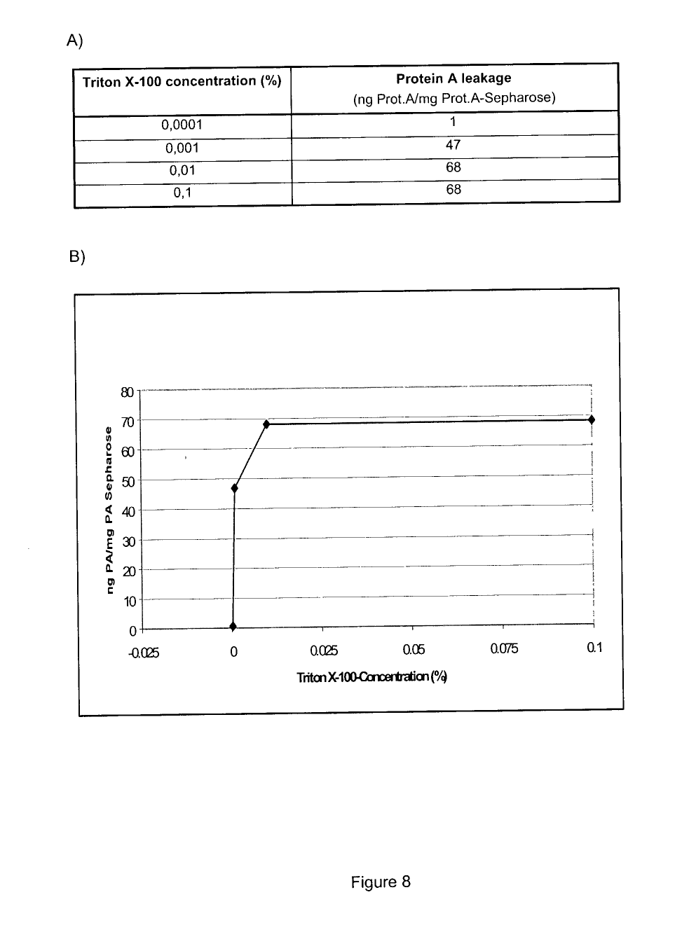

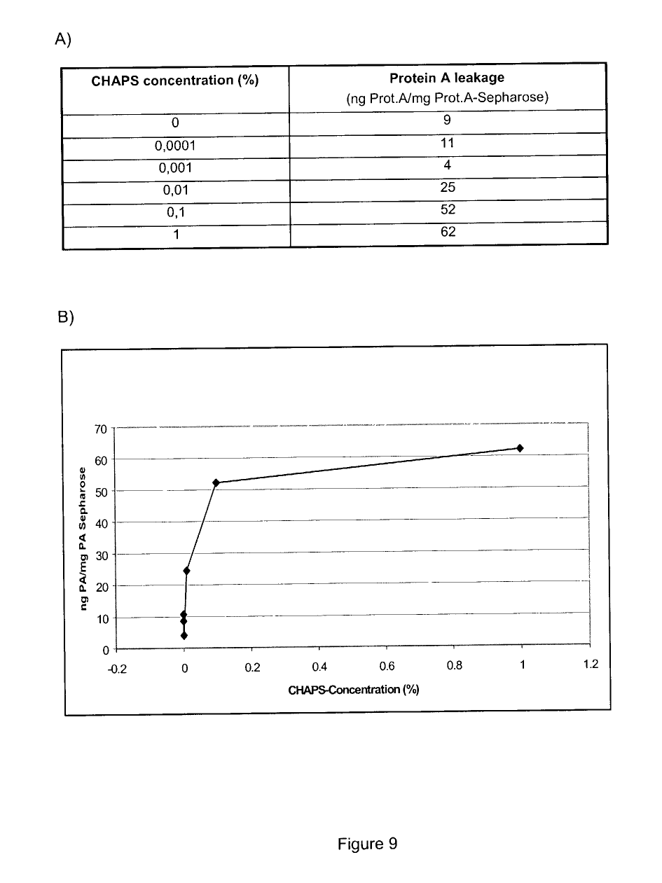

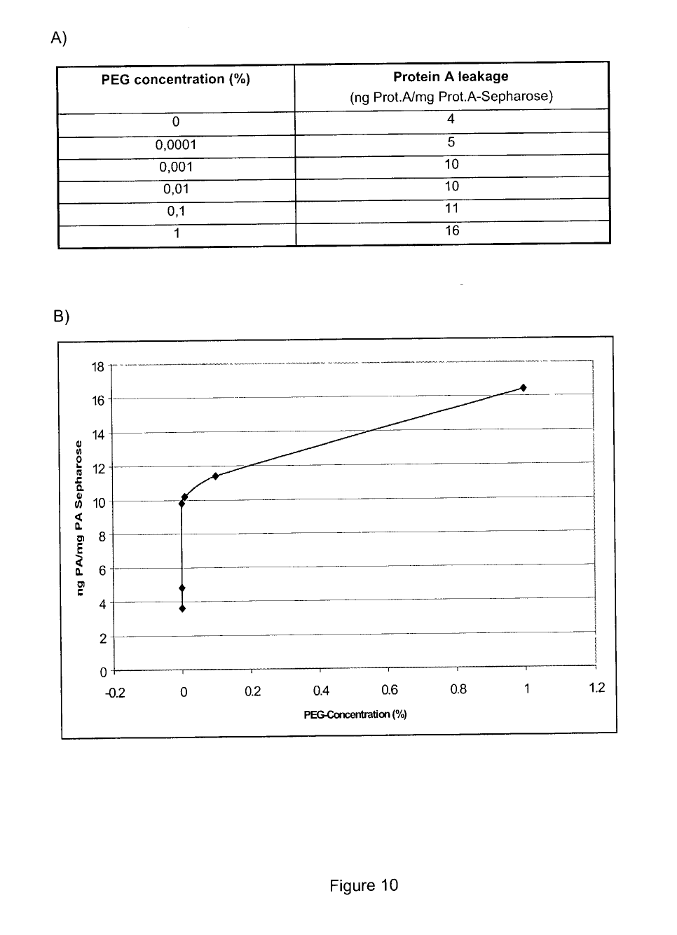

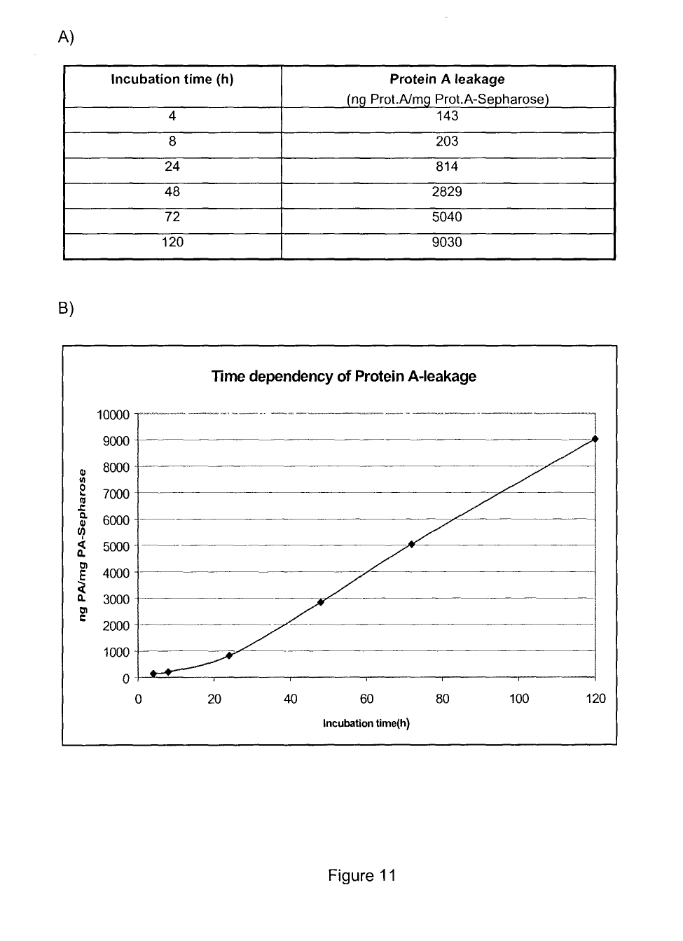

The induction of the protein A leakage depends on the concentration of the detergent used, Protein A sepharose treated according to the method described in FIG. 2, using cell culture medium was used to determine the optimum concentration range of detergent. Ligand leakage was determined by Protein A ELISA. As shown in FIGS. 6-10, the optimum concentration range of the detergent used was between 0.001-1.0%, depending on the substance. The optimum detergent concentration was determined by the incubation test or the small scale process or a test based on a comparable process for each application of the affinity matrix.

Time Dependency of the Protein A Leakage Reaction

The time dependency of the reaction/pre-treatment of the protein A sepharose was demonstrated in incubation experiments. If protein A sepharose was incubated in detergent-containing buffer, for example in 0.1% Pluronic F68 according to the method described in FIG. 2 using cell culture medium as the probe, the leakage of the protein A sepharose was dependent on time (FIG. 11). It was found that, surprisingly, a significant reduction in the protein A leakage was only achieved after a treatment time (i.e., “contact time” or “duration of treatment”) of at least 16 to 24 hours. FIG. 14 also shows that the contact time at 25° C. was ideally 16 to 48 hours. If the temperature was raised to above 25° C., e.g. to 37° C., the treatment time required was shortened considerably to at least 4 hours, and was ideally 4-16 hours. Similarly, there was a direct volume dependency of the pre-treatment of the protein A matrix with detergent.

Temperature Dependency of the Protein A Leakage Reaction

Protein A leakage is dependent on the incubation temperature. Using the method described in FIG. 2 minus treatment with detergent (probe was cell culture medium; incubation time was 16 hours) a comparison of the ligand leakage (measured by protein A ELISA) of protein A sepharose in two independent test series at 2-8° C., 25° C. (RT) and 37° C. or 2-8° C., 37° C., 45° C., 50° C. and 55° C. showed that the ligand leakage was directly dependent on the temperature: the higher the incubation temperature, the more effectively was unstable or non-covalently bound protein A dissolved out of the affinity matrix (FIG. 12). The ideal incubation temperature for industrial applications was 20-25° C. (RT). If necessary the temperature may also be raised to 37° C. or above, for example to about 50° C. or even to about 55° C., as a result of which both the length of treatment and the rinsing volume required can be reduced accordingly while achieving the same effect (cf. also FIG. 14).

Pre-Treatment of Various Protein A Matrices

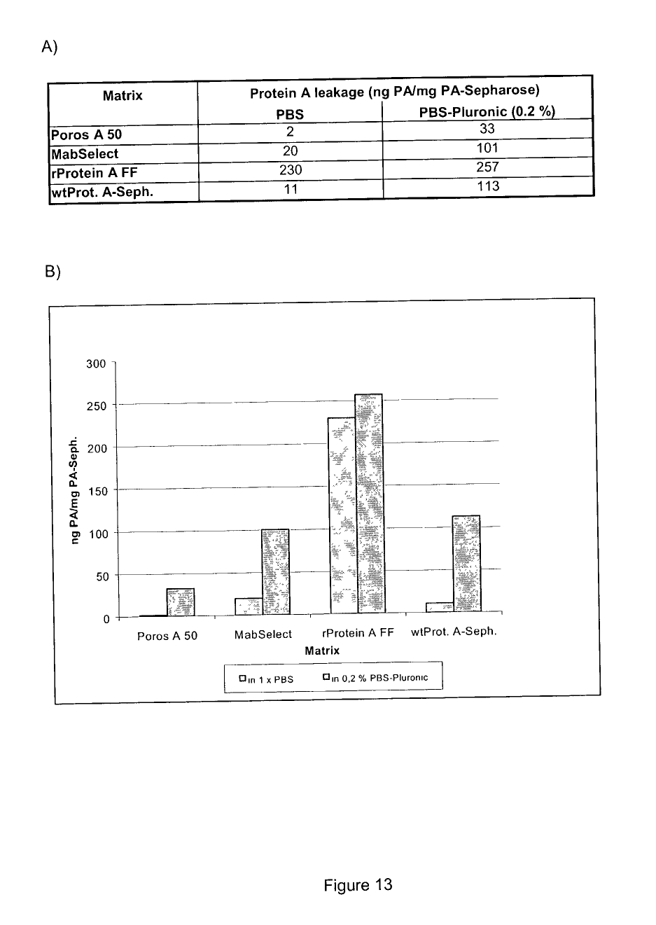

As shown in FIG. 13, the induction of the protein A leakage was obtained for various protein A matrices (e.g. wild-type/rec. protein A sepharose, MabSelect™, etc.) after the matrices were treated with detergent according to the invention illustrated in FIG. 2 (probe was cell culture medium; incubation was 16 hours at 37° C.). The leakage test used was according to that shown in FIG. 2 without treatment with detergent, and was measured by protein A ELISA.

What is claimed is:

1. A process for treating an affinity chromatography matrix in order to reduce the ligand leakage comprising treating the affinity chromatography matrix with at least one surfactant, wherein the duration of treatment with the surfactant is at least 4 hours.

2. The process according to claim 1, wherein the duration of treatment is 4 to 16 hours.

3. The process according to claim 1, wherein the duration of treatment is at least 16 hours.

4. The process according to claim 1, wherein the duration of treatment is 16 to 48 hours.

5. The process according to claim 1, wherein the process is performed at a temperature from about 25° C. to about 55° C.

6. The process according to claim 3, wherein the process is performed at a temperature from about 15° C. to about 25° C.

7. The process according to claim 5, wherein the duration of treatment is 4 to 16 hours.

8. The process according to claim 6, wherein the duration of treatment is 16 to 48 hours.

9. The process according to claim 1, wherein the affinity chromatography matrix is rinsed with 5 to 15 bed volumes of the surfactant.

10. The process according to claim 9, wherein the affinity chromatography matrix is treated with a chaotropic substance, before, during, or after treatment with the surfactant.

11. The process according to claim 10, wherein the affinity chromatography matrix is treated with an elution buffer which is stringent for the affinity matrix during or after treatment with the chaotropic substance.

12. The process according to claim 11, wherein the affinity chromatography matrix is treated during or after treatment with the elution buffer with a neutral equilibration buffer having a pH of about 6.5 to about 8.5.

13. The process according to claim 10 wherein the chaotropic substance is urea or guanidine hydrochloride.

14. The process according to claim 13, wherein the chaotropic substance is used at a concentration of 4M to 6 M.

15. The process according to claim 10, wherein the elution buffer is an acidic elution buffer having a pH of about 2.0 to about 4.0.

16. A process for treating an affinity chromatography matrix comprising the steps of:
a. pre-treating the affinity chromatography matrix comprising:
i. treating the affinity chromatography matrix with a chaotropic substance;
ii. treating the affinity chromatography matrix with an acidic elution buffer having a pH of about 2.0 to about 4.0; and
iii. treating the affinity chromatography matrix with a neutral equilibration buffer having a pH of about 6.5 to about 8.5;
b. treating the affinity chromatography matrix with 5 to 15 bed volumes of at least one surfactant for at least 4 hours at a process temperature ranging from about 25° C. to 55° C.; and, optionally,
c. post-treating the affinity chromatography matrix comprising:
i. treating the affinity chromatography matrix with a chaotropic substance;
ii. treating the affinity chromatography matrix with an acidic elution buffer having a pH of about 2.0 to about 4.0; and
iii. treating the affinity chromatography matrix with a neutral equilibration buffer having a pH of about 6.5 to about 8.5.

17. A process for treating an affinity chromatography matrix comprising the steps of:
a. pre-treating the affinity chromatography matrix comprising:
i. treating the affinity chromatography matrix with a chaotropic substance;
ii. treating the affinity chromatography matrix with an acidic elution buffer having a pH of about 2.0 to about 4.0; and
iii. treating the affinity chromatography matrix with a neutral equilibration buffer having a pH of about 6.5 to about 8.5;
b. treating the affinity chromatography matrix with 5 to 15 bed volumes of at least one surfactant for at least 16 hours at a process temperature less than 25° C.; and, optionally,
c. post-treating the affinity chromatography matrix comprising:
i. treating the affinity chromatography matrix with a chaotropic substance;
ii. treating the affinity chromatography matrix with an acidic buffer having a pH of about 2.0 to about 4.0; and
iii. treating the affinity chromatography matrix with a neutral equilibration buffer having a pH of about 6.5 to about 8.5.

18. A process for treating an affinity chromatography matrix comprising treating the affinity chromatography matrix with a solution comprising: (a) a chaotropic substance; (b) an acidic elution buffer having a pH of about 2.0 to about 4.0; (c) a neutral equilibration buffer having a pH of about 6.5 to about 8.5; and (d) 5 to 15 bed volumes of at least one surfactant, wherein the affinity chromatography matrix is treated for at least 4 hours at a process temperature ranging from about 25° C. to 55° C.

19. A process for treating an affinity chromatography matrix comprising treating the affinity chromatography matrix with a solution comprising: (a) a chaotropic substance; (b) an acidic buffer having a pH of about 2.0 to about 4.0; (c) a neutral equilibration buffer having a pH of about 6.5 to about 8.5; and (d) 5 to 15 bed volumes of at least one surfactant, wherein the affinity chromatography matrix is treated with 5 to 15 bed volumes of at least one surfactant for at least 16 hours at a process temperature less than 25° C.

20. The process according to claim 18 or 19. wherein the affinity chromatography matrix is pre-treated comprising:
a. treating the affinity chromatography matrix with a chaotropic substance;
b. treating the affinity chromatography matrix with an acidic buffer having a pH of about 2.0 to about 4.0; and
c. treating the affinity chromatography matrix with a neutral equilibration buffer having a pH of about 6.5 to about 8.5.

21. The process according to claim 18 or 19. wherein the affinity chromatography matrix is post-treated comprising:
a. treating the affinity chromatography matrix with a chaotropic substance;
b. treating the affinity chromatography matrix with an acidic buffer having a pH of about 2.0 to about 4.0; and
c. treating the affinity chromatography matrix with a neutral equilibration buffer having a pH of about 6.5 to about 8.5.

22. The process according to claim 1, wherein the surfactant is a non-ionic detergent or a zwitterionic detergent.

23. The process according to claim 22, wherein the non-ionic detergent is a polyethylene glycol-alkylether, a polyethylene glycol-sorbitan fatty acid ester, an alkylphenyl-polyethylene glycol-ether, a polyethyleneoxide-polypropyleneoxide block copolymer, a nonylphenol polyoxyethylene ether, a branched polyoxyethylene-nonylcyclohexyl ether, or a polyethylene glycol.

24. The process according to claim 23, wherein the non-ionic detergent is selected from the group consisting of: polyoxyethylene(23)laurylether, polyoxyl-20-cetostearylether, polyoxyethylene(20) sorbitan-monolaurate (Polysorbate 20), polyoxyethylene(20)sorbitan monooleate (Polysorbate 80), t-octylphenoxy-polyethoxyethanol, polyglycolether, isooctylphenoxypolyethoxyphenol, polyoxyethylene-polyoxypropylene block copolymer, and polyethylene glycol.

25. The process according to claim 22, wherein the zwitterionic detergent is 3-(3-cholamidopropyl)-dimethylammonio-1-propanesulphonate (CHAPS) or 3-(3-cholamidopropyl)-dimethyl-ammonio-2-hydroxy-1-propanesulphonate (CHAPSO).

26. The process according to claim 22, wherein the surfactant is used in a concentration of 0.001 to 5% (v/v).

27. The process according to claim 24, wherein the polyoxyethylene(20)sorbitan-monolaurate (Polysorbate 20) or polyoxyethylene(20)sorbitan-monooleate (Polysorbate 80) is used in a concentration of 0.001 to 0.5% (v/v).

28. The process according to claim 24, wherein the polyoxyethylene-polyoxypropylene block copolymer or t-octyl-phenoxypolyethoxyethanol is used in a concentration of 0.001 to 0.1% (v/v).

29. The process according to claim 24, wherein the polyethylene glycol is used in a concentration of 0.001 to 1% (v/v).

30. The process according to claim 22, wherein the zwitterionic detergent is used in a concentration of 0.01 to 5%.

31. The process according to claim 25, wherein 3-(3-cholamidopropyl)-dimethylammonio-1-propanesulphonate (CHAPS) or 3-(3-cholamidopropyl)-dimethyl-ammonio-2-hydroxy-1-propanesulphonate (CHAPSO) is used in a concentration 0.01% to 5% (v/v).

32. The process according to claim 25, wherein 3-(3-cholamidopropyl)-dimethylammonio-1-propanesulphonate (CHAPS) or 3-(3-cholamidopropyl)-dimethyl-ammonio-2-hydroxy-1-propanesulphonate (CHAPSO) is used in a concentration of 0.01 to 1% (v/v).

33. The process according to claim 1, wherein the affinity chromatography matrix is a protein A matrix.

34. The process according to claim 33, wherein the protein A matrix comprises immobilized wild-type or recombinantly prepared protein A.

35. The process according to claim 33, wherein the protein A matrix is coupled to agarose, or to a polysaccharide, or to dextran, or to silica gel, or to glass beads.

36. The process according to claim 34, wherein the protein A matrix is coupled to agarose, or to a polysaccharide, or to dextran, or to silica gel, or to glass beads.

37. The process according to claim 33, wherein the affinity chromatography matrix is protein A sepharose.

38. The process according to claim 1, wherein the ligand leakage is reduced to a level of less than 80 ng/mg affinity matrix after treatment with the surfactant.

39. The process according to claim 38, wherein the ligand leakage is reduced to a level of less than 40 ng/mg affinity matrix.

40. The process according to claim 39, wherein the ligand leakage is reduced to a level of less than 20 ng/mg affinity matrix.

41. The process according to claim 40, wherein the ligand leakage is reduced to a level of less than 10 ng/mg affinity matrix.

42. A low leakage affinity chromatography matrix, which has been treated by a process according to claim 1.

43. A low leakage protein A matrix, which has been treated by a process according to claim 1.

44. A method of determining ligand leakage of an affinity chromatography matrix comprising the steps of:
a. treating the affinity chromatography matrix by a process according to one of claims 1, 16, or 17;
b. incubating the treated affinity chromatography matrix with a probe solution; and
c. quantifying the ligand in the probe solution using a suitable quantitative test.

45. The method according to claim 44, wherein the probe solution is the intermediate product which is used as starting material in the process.

46. The method according to claim 44, wherein that quantitative test is a ligand-specific ELISA.

47. The method according to claim 44, wherein the ligand is protein A.

48. A method of determining ligand leakage comprising the steps of:
a. treating the affinity chromatography matrix by a process according to one of claims 1, 16, or 17;
b. charging the affinity chromatography matrix with a substance to be purified;
c. washing the affinity chromatography matrix with a stringent washing buffer;
d. incubating the affinity chromatography matrix with an elution buffer; and
e. quantifying the ligand in the elution buffer by means of a suitable quantitative test.

49. The method according to claim 48, wherein the quantitative test is a ligand-specific ELISA.

50. The method according to claim 48, wherein the ligand is protein A.

51. A method for purifying a biopharmaceutical product comprising:
a. incubating an affinity matrix column prepared according to one of claims 1, 16, or 17 with the biopharmaceutical product in solution; and
b. eluting the biopharmaceutical product with an elution buffer.

52. A method for purifying an antibody, chimeric antibody, or a fragment or derivative thereof comprising:
a. incubating an affinity matrix column prepared according to one of claims 1, 16, or 17 with the antibody, chimeric antibody, or fragment or derivative thereof in solution; and
b. eluting the antibody, chimeric antibody, or fragment or derivative thereof with an elution buffer.
